(19) United States
(12) Patent Application Publication
(10) Pub. No.: US 2026/0284594 A1
(43) Pub. Date: Sep. 24, 2026

(54) COMPOSITE OF MANGANESE-BASED OXIDE AND ZEOLITE USEFUL AS NH3-SCR CATALYST

(71) Applicant: BASF CORPORATION

(72) Inventors: Dengsong ZHANG, Shanghai (CN); Penglu WANG, Shanghai (CN); Lupeng HAN, Shanghai (CN); Yuejin LI, Iselin, NJ (US); Yufen HAO, Shanghai (CN)

(21) Appl. No.: 19/476,366

(22) PCT Filed: May 29, 2024
(86) PCT No.: PCT/CN2024/096078

§ 371 Date: Oct. 17, 2025

(30) Foreign Application Priority Data
May 29, 2023 (WO) PCT/CN2023/096842

(51) Int. Cl. B01D 53/94; B01J 29/48; B01J 35/57; B01J 37/00; B01J 37/02; B01J 37/03; B01J 37/08; F01N 3/022; F01N 3/035; F01N 3/10; F01N 3/20; F01N 3/28

(52) U.S. Cl. CPC B01D 53/9418; B01D 53/9477; B01J 29/48; B01J 35/57; B01J 37/0036; B01J 37/0236; B01J 37/036; B01J 37/08; F01N 3/022; F01N 3/035; F01N 3/101; F01N 3/106; F01N 3/2066; F01N 3/2803; B01D 2251/2062; B01D 2255/2065; B01D 2255/2073; B01D 2255/40; B01D 2255/504; B01D 2255/9155; B01D 2257/404; B01D 2258/012; F01N 2370/04; F01N 2610/02

(57) ABSTRACT

The present invention relates to an NH₃-SCR catalyst comprising a composite of manganese oxide, cerium oxide and a molecular sieve, wherein the molecular sieve is present in an amount of 20% to 70% by weight, based on the total weight of the composite. The present invention also relates a sol-gel process for preparing the NH₃-SCR catalyst, a SCR catalytic article comprising the NH₃-SCR catalyst, and an exhaust gas treatment system comprising the SCR catalytic article.

### FIELD OF THE INVENTION

The present invention relates to a composite of manganese-based oxide and zeolite useful as a catalyst for selective catalytic reduction (SCR) of nitrogen oxides in engine exhaust, a SCR catalytic article comprising the composite, an exhaust gas treatment system comprising the SCR catalytic article, and a process for preparation of the composite of manganese-based oxide and zeolite.

### BACKGROUND OF THE INVENTION

Nitrogen oxides (NOX) are common air pollutants, which are generally contained in exhaust gases from mobile sources such as automobiles and stationary sources such as power plants. Control of NOx emission is always one of the most important topics for example in automobile manufacturing field, due to the environmentally negative impact of NOx on ecosystem, human beings, animals and plants.

Various treatment methods have been used for the treatment of NOx-containing gas mixtures to decrease atmospheric pollution. One of the well-known types of treatment is the selective catalytic reduction (SCR) process with ammonia or an ammonia precursor as a reducing agent, also referred to as NH₃-SCR process. The NH₃-SCR process is considered superior since a high degree of NOx abatement can be obtained with a small amount of reducing agent. In the NH₃-SCR process, NOx is catalytically reduced with the reducing agent (e.g., ammonia or urea) in the presence of atmospheric oxygen, resulting in the formation predominantly of nitrogen and steam,

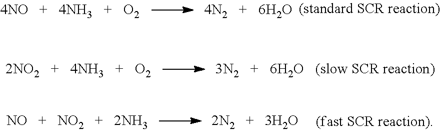

A side reaction accompanying the selective catalytic reduction of NOx is the formation of low-valent nitrogen oxides, especially nitrous oxide (N₂O) from the reducing agent NH₃ and oxygen.

Current catalysts employed in the SCR process include copper-promoted zeolites (e.g., copper-promoted CHA). However, regulations worldwide mandate ever lower emissions from vehicles. Efficient removal of NOx at low temperatures (<200° C.) is an unmet need and a great challenge for the industry in general. Cu-promoted zeolites are the most active type of catalyst for NH₃-SCR for diesel vehicles, but such SCR catalyst lack sufficient activity at low temperatures such as below 200° C. At low temperatures, Cu-promoted zeolite catalysts also need to be saturated with ammonia (NH₃) before they can be effective for NOx reduction, which slows down the response to reducing agent (e.g., urea injection). Vanadia/titania (V₂O₅/TiO₂) based catalysts represent another type of current SCR catalysts, which require less NH₃ to reach saturation, but are much less active at low temperatures relative to copper-promoted zeolite catalysts. Another drawback of vanadium-based catalysts is the environmental concern associated with possible escape of V₂O₅ to the atmosphere with use of such catalysts.

Manganese oxide-based catalysts were known useful and effective for the NH₃-SCR reaction at low temperatures, which may be manganese oxide or Mn-based multi-metal oxide. Manganese oxide usually produces high emission of N₂O, and thus results in poor N₂ selectivity. It was found that Mn-based multi-metal oxides such as a composite oxide of manganese and cerium (also referred to as “MnCeOx”) could exhibit a superior SCR activity at low temperatures with reduced emission of N₂O. However, the emission of N₂O is still unsatisfactory in view of the stringent emission regulations.

There is a need to provide an NH₃-SCR catalyst which could exhibit desirable NOx conversion level, particularly at a lower temperature, while resulting in reduced N₂O emission, as well as a process for preparing an NH₃-SCR catalyst presenting such catalytic performances.

### SUMMARY OF THE INVENTION

It is an object of the present invention to provide a SCR catalyst which exhibits desirable NOx conversion level and result in acceptable level of N₂O emission, especially under low temperatures (e.g., 200° C. and lower).

It has surprisingly been found that the object was achieved by a composite of a manganese (Mn) species, a cerium (Ce) species and a zeolite species.

Another object of the present invention is to provide a process particularly useful for preparing a SCR catalyst exhibiting high NOx conversion level as well as low N₂O emission.

The object was achieved by a process including preparation of a composite of a manganese (Mn) species, a cerium (Ce) species and a zeolite species through a sol-gel method.

Accordingly, in a first aspect, the present invention relates to an NH₃-SCR catalyst which comprises, particularly consists of, a composite of manganese oxide, cerium oxide and a molecular sieve, wherein the molecular sieve is present in an amount of 20% to 70% by weight, based on the total weight of the composite.

In a second aspect, the present invention relates to a sol-gel process for preparing the NH₃-SCR catalyst as described herein, which includes steps of
(i) providing a suspension comprising a molecular sieve, a precursor of manganese oxide and a precursor of cerium oxide,
(ii) heating the suspension to form a gel, and
(iii) subjecting the gel to drying, grinding and calcining.

In a third aspect, the present invention relates to an NH₃-SCR article, which comprises the NH₃-SCR catalyst as described herein and is preferably in form of shaped bodies or coated structures.

In a fourth aspect, the present invention relates to a method for treatment of exhaust gases containing nitrogen oxides by selective catalytic reduction, which includes contacting the exhaust gas with the NH₃-SCR catalyst or the NH₃-SCR article as described herein in the presence of ammonia or ammonia precursor as a reducing agent.

In a fifth aspect, the present invention relates to an exhaust gas treatment system for combustion engines, which comprises a reducing agent source, the NH₃-SCR article as described herein, and optionally one or more of diesel oxidation catalyst (DOC), three-way conversion catalyst (TWC), four-way conversion catalyst (FWC), non-catalyzed or catalyzed soot filter (CSF), ammonia oxidation catalyst (AMOx), NOx trap, NOx absorber catalyst, hydrocarbon trap catalyst, sensor and mixer.

It has been found by the inventors that the composite containing manganese oxide, cerium oxide and a molecular sieve is particularly useful as or in an NH₃-SCR catalyst to provide desirable NOx conversion level and result in acceptable level of N₂O emission, especially under a low temperature (e.g., 200° C. or lower).

### BRIEF DESCRIPTION OF THE DRAWINGS

FIG. 1 show XRD patterns of NH₄⁺-ZSM-5, a composite of MnCeOx at fresh and aged states, and a composite of manganese oxide, cerium oxide and NH₄⁺-ZSM-5 according to the present invention (Mn/Ce/NH₄⁺-ZSM-5) at fresh and aged states, respectively.

FIG. 2a shows the SEM-EDS images of a composite of manganese oxide, cerium oxide and NH₄⁺-ZSM-5 according to the present invention (Mn/Ce/NH₄⁺-ZSM-5) at a fresh state.

FIG. 2b shows the SEM-EDS images of a composite of manganese oxide, cerium oxide and NH₄⁺-ZSM-5 according to the present invention (Mn/Ce/NH₄⁺-ZSM-5) at an aged state.

### DETAILED DESCRIPTION OF THE INVENTION

The present invention will be described in detail hereinafter. It is to be understood that the present invention may be embodied in many different ways and shall not be construed as limited to the embodiments set forth herein.

Herein, the singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

As used herein, the term “molecular sieve” refers to framework materials such as zeolites and other framework materials (e.g., isomorphously substituted materials), which may in particulate form, and in combination with one or more promotor metals, be used as catalysts. Molecular sieves are materials based on an extensive three-dimensional network of oxygen ions containing generally tetrahedral type sites and having a substantially uniform pore distribution.

As used herein, the term “zeolite” refers to a specific example of a molecular sieve. Generally, a zeolite is defined as an aluminosilicate with an open 3-dimensional framework structure composed of corner-sharing TO₄ tetrahedra, where T is for example Al or Si. Cations that balance the charge of the anionic framework are loosely associated with the framework oxygens. For purposes of this disclosure, the term “aluminosilicate zeolites” does not include phosphorus or other metals isomorphically substituted in the framework. That is, “aluminosilicate zeolite” excludes aluminophosphate materials such as SAPO, AlPO and MeA1PO materials, while the broader term “zeolite” includes aluminosilicates and aluminophosphates.

As used herein, the term “composite” refers to a material consisting of a manganese species, a cerium species and a molecular sieve species which are combined with each other in a uniformly dispersed manner rather than being present as dispersed individuals, as determined by SEM-EDS. A physical mixture of those species obtained by physical means, for example by mechanical mixing or blending is not encompassed in the term.

As used herein, the term “manganese oxide” is intended to encompass manganese in any possible oxidation state, such as MnO, Mn₂O₃, Mn₃O₄, MnO₂, MnO₃, Mn₂O₇, or any combinations thereof.

Also, the term “cerium oxide” is intended to encompass cerium in any possible oxidation state, such as CeO₂, Ce₂O₃, Ce₃O₄, or any combinations thereof.

The term “catalytic article” as used herein is just intended to mean an item with a certain shape having a catalytic function, which is not necessarily a single body. In other words, the catalytic article may be a single body or consist of two or more separable bodies.

In the first aspect, the present invention provides an NH₃-SCR catalyst which comprises, particularly consists of, a composite of manganese oxide, cerium oxide and a molecular sieve, wherein the molecular sieve is present in an amount of 20% to 70% by weight, based on the total weight of the composite.

In some embodiments, the NH₃-SCR catalyst consists of a composite of manganese oxide, cerium oxide and a molecular sieve, wherein the molecular sieve is present in an amount of 20% to 70% by weight, based on the total weight of the composite.

According to the present invention, the molecular sieve is preferably present in the composite of manganese oxide, cerium oxide and a molecular sieve in an amount of 20% to 50% by weight, more preferably 35% to 45% by weight, based on the total weight of the composite.

In the composite as described herein, manganese oxide and cerium oxide are present at a molar ratio in the range of 4:1 to 1:4, preferably in the range of 7:3 to 3:7, more preferably in the range of 3:2 to 2:3, calculated as Mn and Ce elements.

For the purpose of the present invention, suitable molecular sieves may include, but are not limited to zeolites having a framework type selected from the group consisting of ABW, ACO, AEI, AEL, AEN, AET, AFG, AFI, AFN, AFO, AFR, AFS, AFT, AFV, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, -CHI, -CLO, CON, CSV, CZP, DAC, DDR, DFO, DFT, DOH, DON, EAB, EDI, EEI, EMT, EON, EPI, ERI, ESV, ETR, EUO, *-EWT, EZT, FAR, FAU, FER, FRA, GIS, GIU, GME, GON, GOO, HEU, IFO, IFR, -IFU, IFW, IFY, IHW, IMF, IRN, IRR, -IRY, ISV, ITE, ITG, ITH, *-ITN, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, *MRE, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POS, PSI, PUN, RHO, -RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, *SFV, SFW, SGT, SIV, SOD, SOF, SOS, SSF, *-SSO, SSY, STF, STI, *STO, STT, STW, -SVR, SVV, SZR, TER, THO, TOL, TON, TSC, TUN, UEI, UFI, UOS, UOV, UOZ, USI, UTL, UWY, VET, VFI, VNI, VSV, WEI, -WEN, YUG, ZON, and any combinations thereof.

Particularly, suitable molecular sieves may be zeolites having a framework type selected from the group consisting of AEI, AEL, AFI, AFT, AFO, AFX, AFR, ATO, BEA, CHA, DDR, EAB, EMT, ERI, EUO, FAU, FER, GME, HEU, JSR, KFI, LEV, LTA, LTL, LTN, MAZ, MEL, MFI, MOR, MOZ, MSO, MTW, MWW, OFF, RTH, SAS, SAT, SAV, SBS, SBT, SFW, SSF, SZR, TON, TSC, WEN, and any combinations thereof.

It will be appreciated that when a zeolite is mentioned by reference to the framework type code as generally accepted by the International Zeolite Association (IZA) herein, it is intended to include not only the reference material but also any isotypic framework materials having SCR catalytic activities. The list of reference material and the isotypic framework materials for each framework type code are available from the database of IZA (http://www.iza-structure.org/databases/).

There is no particular restriction to the cations that balance the charge of the anionic framework in the zeolites useful as the molecular sieve in the composite as described herein. In other words, the zeolites as described hereinabove may be in their H-form, NH₄⁺-form, metal ion-exchanged form such as copper- and/or iron-exchanged form, and any other suitable forms.

In some embodiments, the molecular sieve in the composite as described herein is a zeolite having a framework type selected from the group consisting of BEA (e.g., Beta), CHA (e.g., chabazite), FAU (e.g., zeolite Y), FER (e.g., ferrierite), MFI (e.g., ZSM-5) and MOR (e.g., mordenite). The molecular sieve in the composite as described herein is particularly a zeolite having an MFI framework, e.g., ZSM-5, preferably H-form of ZSM-5 (H-ZSM-5) or NH₄⁺-form of ZSM-5 (NH₄⁺-ZSM-5), especially NH₄⁺-form of ZSM-5.

The zeolites useful as the molecular sieve in the composite as described herein may have a SiO₂/Al₂O₃ molar ratio (SAR) in the range of 5:1 to 150:1, preferably 5:1 to 50:1.

The molecular sieve may have a BET surface area of at least 150 m²/g, at least 250 m²/g or at least 300 m²/g, as determined according to DIN 66131.

In some illustrative embodiments, the NH₃-SCR catalyst according to the present invention consists of a composite of manganese oxide, cerium oxide and a molecular sieve, wherein the molecular sieve is present in an amount of 20% to 70% by weight, based on the total weight of the composite, and wherein the molecular sieve is a zeolite having a framework type selected from the group consisting of BEA (e.g., Beta), CHA (e.g., chabazite), FAU (e.g., zeolite Y), FER (e.g., ferrierite), MFI (e.g., ZSM-5) and MOR (e.g., mordenite).

In those illustrative embodiments, the molecular sieve is preferably present in an amount of 20% to 50% by weight, based on the total weight of the composite. In those illustrative embodiments, the molecular sieve is more preferably present in an amount of 35% to 45% by weight, based on the total weight of the composite.

In some particular embodiments, the NH₃-SCR catalyst according to the present invention consists of a composite of manganese oxide, cerium oxide and a molecular sieve, wherein the molecular sieve is present in an amount of 20% to 50% by weight, based on the total weight of the composite, and wherein the molecular sieve is a zeolite having a framework type selected from the group consisting of BEA (e.g., Beta), CHA (e.g., chabazite), FAU (e.g., zeolite Y), FER (e.g., ferrierite), MFI (e.g., ZSM-5) and MOR (e.g., mordenite), in their H-form or NH₄⁺-form.

More particularly, the NH₃-SCR catalyst according to the present invention consists of a composite of manganese oxide, cerium oxide and a molecular sieve, wherein the molecular sieve is present in an amount of 35% to 45% by weight, based on the total weight of the composite, and wherein the molecular sieve is a zeolite having a framework type of MFI (e.g., ZSM-5) in its NH₄⁺-form.

In some other illustrative embodiments, the NH₃-SCR catalyst according to the present invention consists of a composite of manganese oxide, cerium oxide and a molecular sieve, wherein
the molecular sieve is present in an amount of 20% to 70% by weight, based on the total weight of the composite,
manganese oxide and cerium oxide are present at a molar ratio in the range of 4:1 to 1:4, and
the molecular sieve is a zeolite having a framework type selected from the group consisting of BEA (e.g., Beta), CHA (e.g., chabazite), FAU (e.g., zeolite Y), FER (e.g., ferrierite), MFI (e.g., ZSM-5) and MOR (e.g., mordenite).

Preferably, the NH₃-SCR catalyst according to the present invention consists of a composite of manganese oxide, cerium oxide and a molecular sieve, wherein
the molecular sieve is present in an amount of 20% to 50% by weight, based on the total weight of the composite,
manganese oxide and cerium oxide are present at a molar ratio in the range of 7:3 to 3:7, and
the molecular sieve is a zeolite having a framework type selected from the group consisting of BEA (e.g., Beta), CHA (e.g., chabazite), FAU (e.g., zeolite Y), FER (e.g., ferrierite), MFI (e.g., ZSM-5) and MOR (e.g., mordenite).

More preferably, the NH₃-SCR catalyst according to the present invention consists of a composite of manganese oxide, cerium oxide and a molecular sieve, wherein
the molecular sieve is present in an amount of 35% to 45% by weight, based on the total weight of the composite,
manganese oxide and cerium oxide are present at a molar ratio in the range of 3:2 to 2:3 and
the molecular sieve is a zeolite having a framework type selected from the group consisting of BEA (e.g., Beta), CHA (e.g., chabazite), FAU (e.g., zeolite Y), FER (e.g., ferrierite), MFI (e.g., ZSM-5) and MOR (e.g., mordenite).

Most preferably, the NH₃-SCR catalyst according to the present invention consists of a composite of manganese oxide, cerium oxide and a molecular sieve, wherein
the molecular sieve is present in an amount of 35% to 45% by weight, based on the total weight of the composite,
manganese oxide and cerium oxide are present at a molar ratio in the range of 3:2 to 2:3 and
the molecular sieve is a zeolite having a framework type of MFI (e.g., ZSM-5) in its NH₄⁺-form.

In some embodiments, the composite as described herein contain a phase of CeO₂ ([111]) with a crystallite size of 3.5 nm or less, for example 3.2 nm or less in a fresh state, and/or with a crystallite size of 6.5 nm or less, for example 6.0 nm or less after a hydrothermal aging at a temperature of 650° C. in an atmosphere of air with 10% steam for 50 hours. The crystallite size of CeO₂ ([111]) is determined by X-ray powder diffraction (XRD) analysis.

The composite as described herein may have a BET specific surface area of at least 100 m²/g, for example at least 150 m²/g in a fresh state, and/or a BET specific surface area of at least 50 m²/g, for example at least 75 m²/g or at least 100 m²/g after a hydrothermal aging at a temperature of 650° C. in an atmosphere of air with 10% steam for 50 hours.

The composite as described herein, i.e., the composite of manganese oxide, cerium oxide and a molecular sieve, may be prepared from any suitable process which can provide the composite from a manganese precursor, a cerium precursor and a molecular sieve. Preferably, the composite of manganese oxide, cerium oxide and a molecular sieve may be prepared via a co-precipitation process or a sol-gel process, more preferably prepared via a sol-gel process.

It has been surprisingly found by the inventors that the composite of manganese oxide, cerium oxide and a molecular sieve prepared via a sol-gel process is particularly advantageous with respect to the low-temperature catalytic performance of the composite, when being used in an NH₃-SCR process.

Accordingly, in the second aspect, the present invention provides a sol-gel process for preparing the NH₃-SCR catalyst as described in the first aspect, which includes steps of
(i) providing a suspension comprising a molecular sieve, a precursor of manganese oxide and a precursor of cerium oxide,
(ii) heating the suspension to form a gel, and
(iii) subjecting the gel to drying, grinding and calcining.

Suitable molecular sieves for the sol-gel process according to the present invention are those as described generally and with preference in the first aspect hereinabove.

The term “precursor” as used herein refers to a material which may decompose or otherwise convert to respective catalytically active species (i.e., manganese oxide and cerium oxide respectively), upon calcination or use of the catalyst.

Suitable precursors of manganese oxide for the sol-gel process according the present invention may be any inorganic or organic, water-soluble or water-dispersible compounds of manganese, such as salts and complexes of manganese. Also, suitable precursors of cerium oxide for the sol-gel process according the present invention may be any inorganic or organic, water-soluble or water-dispersible compounds of cerium, such as salts and complexes of cerium.

Particularly, the suspension in step (i) further comprises an aqueous medium, preferably water, more preferably deionized water (DI water) or demineralized water.

The suspension in step (i) may further comprise a complexing agent such as citric acid.

In step (i), the suspension may be provided by preparing a mixture containing a molecular sieve, a precursor of manganese oxide and a precursor of cerium oxide, and then dissolve the mixture into an aqueous medium, preferably DI water. The mixture may also contain the complexing agent such as citric acid.

In step (ii), the suspension as obtained from step (i) is heated, preferably under stirring, to form a gel. The heating may be carried out at a temperature in the range of 70° C. to 100° C., for example in the range of 80° C. to 90° C.

In step (iii), the gel as obtained from step (ii) is subjected to drying, grinding and calcining. The drying, grinding and calcining may be carried out in any conventional manners and conditions well-known in the art. Particularly, the drying may be carried out at a temperature in the range of 40 to 100° C., for example 60 to 80° C., to remove the aqueous medium. The resulted solid may further be ground into powder having a suitable particle size. Then, the powder is subjected to calcining at a temperature in the range of 300° C. to 500° C., for example 300° C. or 400° C., to provide a composite of manganese oxide, cerium oxide and a molecular sieve.

In some illustrative embodiments, the present invention provides a sol-gel process for preparing the NH₃-SCR catalyst as described in the first aspect, which includes steps of
(i) providing a suspension comprising a molecular sieve, a precursor of manganese oxide, a precursor of cerium oxide, and a complexing agent in an aqueous medium, preferably water,
(ii) heating the suspension to form a gel, and
(iii) subjecting the gel to drying, grinding and calcining.

Particularly, the present invention provides a sol-gel process for preparing the NH₃-SCR catalyst as described in the first aspect, which includes steps of
(i) providing a suspension comprising a molecular sieve, a water-soluble salt of manganese, a water-soluble salt of cerium, and citric acid in water,
(ii) heating the suspension to form a gel, and
(iii) subjecting the gel to drying, grinding and calcining.

It has been found that the NH₃-SCR catalyst prepared by a sol-gel process can exhibit a reduced production of N₂O compared with counterparts prepared via a co-precipitation process, a higher low-temperature NOx conversion compared with counterparts prepared via an impregnation process, and both higher low-temperature NOx conversion and reduced production of N₂O compared with counterparts prepared via mixing a Mn/Ce composite oxide with a molecular sieve.

The NH₃-SCR catalyst as described in the first aspect according to the present invention or the NH₃-SCR catalyst obtained from the sol-gel process as described in the second aspect according to the present invention may be used in applications of exhaust treatment in any conventional forms. For example, the NH₃-SCR catalyst may be used as powders or may be processed into shaped bodies or coated onto a substrate in a conventional manner.

Accordingly, in the third aspect, the present invention provides an NH₃-SCR article, which comprises a NH₃-SCR catalyst as described in the first aspect or obtained from the sol-gel process as described in the second aspect, and is preferably in form of shaped bodies or coated structures.

The NH₃-SCR article may be in form of shaped bodies, for example extrudates, particularly granulate extrudates or monolith extrudates. The granulate extrudates may be of various shapes, such as, pellets, beads, rings, spheres, cylinders, trilobes and quadralobes. The monolith extrudates may have any suitable structures allowing exhaust gas flow through, preferably honeycomb structures. The honeycomb structures may have flow passages as described for the monolithic flow-through and wall-flow structures hereinbelow. The NH₃-SCR article in this form may comprise the NH₃-SCR catalyst and optionally other conventional functional components or processing aids such as binders and lubricants.

Alternatively, the NH₃-SCR article may be in form of coated structures, which comprise the NH₃-SCR catalyst in a coating on a substrate. The substrate generally refers to a structure that is suitable for withstanding conditions encountered in exhaust streams, on which the NH₃-SCR catalyst is carried in the form of coat, especially washcoats.

Suitable substrates may have a monolithic flow-through structure having a plurality of fine, parallel gas flow passages extending from an inlet face to an outlet face of the substrate such that passages are open to fluid flow therethrough. The passages, which are essentially straight paths from their fluid inlet to their fluid outlet, are defined by walls on which the catalytic material is applied as coats, especially washcoats so that the gases flowing through the passages contact the catalytic material.

The substrate may alternatively have a monolithic wall-flow structure having a plurality of fine, parallel gas flow passages extending along from an inlet face to an outlet face of the substrate wherein alternate passages are blocked at opposite ends. The passages are defined by walls on which a catalytic material is applied as coats, especially washcoats so that the gases flowing through the passages contact the catalytic material. The configuration requires the gases flow through the porous walls of the wall-flow substrate to reach the outlet face.

The term “washcoat” has its usual meaning in the art and refers to a thin, adherent coating of a catalytic or other material applied to a substrate. A washcoat is generally formed by preparing a slurry containing the desired catalytic material and optionally processing aids such as binder with a certain solid content (e.g., 15 to 60% by weight) and then applying the slurry onto a substrate, dried and calcined to provide a washcoat.

The NH₃-SCR article according to the present invention may be used to treat exhaust gases from for example stationary combustion devices such as power plants and heating systems for buildings and private households, and mobile combustion devices such as combustion engines of vehicles, especially diesel engines. The NH₃-SCR article according to the present invention may particularly be effective to treat exhaust gases from internal combustion engines, for example diesel engines.

The NH₃-SCR article according to the present invention may be located downstream of an internal combustion engine, such as a diesel engine, in a close-coupled position, in a position downstream of the close-coupled position, or both. It is preferred that the catalytic article according to the present invention is located downstream of an internal combustion engine in a close-coupled position.

Accordingly, in the fourth aspect, the present invention relates to a method for treatment of exhaust gases containing nitrogen oxides by selective catalytic reduction, which includes contacting the exhaust gas with the NH₃-SCR catalyst or the NH₃-SCR article as described herein in the presence of ammonia or ammonia precursor as a reducing agent.

Further, in the fifth aspect, the present invention provides an exhaust gas treatment system for combustion engines, which comprises a reducing agent source, the NH₃-SCR article as described herein, and optionally one or more of diesel oxidation catalyst (DOC), three-way conversion catalyst (TWC), four-way conversion catalyst (FWC), non-catalyzed or catalyzed soot filter (CSF), ammonia oxidation catalyst (AMOx), NOx trap, NOx absorber catalyst, hydrocarbon trap catalyst, sensor and mixer.

It is preferred that the exhaust gas treatment system further comprises a diesel oxidation catalyst located downstream of the engine and upstream of the NH₃-SCR article according to the present invention. In some embodiments, the exhaust gas treatment system preferably comprises both a diesel oxidation catalyst and a catalyzed soot filter located upstream of the catalytic article according to the present invention.

### EMBODIMENTS

Various embodiments are listed below. It will be understood that the embodiments listed below may be combined with all aspects and other embodiments in accordance with the scope of the invention.
1. An NH₃-SCR catalyst, which comprises, particularly consists of, a composite of manganese oxide, cerium oxide and a molecular sieve, wherein the molecular sieve is present in an amount of 20% to 70% by weight, based on the total weight of the composite.
2. The NH₃-SCR catalyst according to Embodiment 1, wherein the molecular sieve is present in the composite of manganese oxide, cerium oxide and a molecular sieve in an amount of 20% to 50% by weight, more preferably 35% to 45% by weight, based on the total weight of the composite.
3. The NH₃-SCR catalyst according to Embodiment 1 or 2, wherein manganese oxide and cerium oxide are present at a molar ratio in the range of 4:1 to 1:4, preferably in the range of 7:3 to 3:7, more preferably in the range of 3:2 to 2:3, calculated as Mn and Ce elements.
4. The NH₃-SCR catalyst according to any of Embodiments 1 to 3, wherein the molecular sieve is selected from zeolites having a framework type of ABW, ACO, AEI, AEL, AEN, AET, AFG, AFI, AFN, AFO, AFR, AFS, AFT, AFV, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, -CHI, -CLO, CON, CSV, CZP, DAC, DDR, DFO, DFT, DOH, DON, EAB, EDI, EEI, EMT, EON, EPI, ERI, ESV, ETR, EUO, *-EWT, EZT, FAR, FAU, FER, FRA, GIS, GIU, GME, GON, GOO, HEU, IFO, IFR, -IFU, IFW, IFY, IHW, IMF, IRN, IRR, -IRY, ISV, ITE, ITG, ITH, *-ITN, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, *MRE, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POS, PSI, PUN, RHO, -RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, *SFV, SFW, SGT, SIV, SOD, SOF, SOS, SSF, *-SSO, SSY, STF, STI, *STO, STT, STW, -SVR, SVV, SZR, TER, THO, TOL, TON, TSC, TUN, UEI, UFI, UOS, UOV, UOZ, USI, UTL, UWY, VET, VFI, VNI, VSV, WEI, -WEN, YUG and ZON.
5. The NH₃-SCR catalyst according to any of Embodiments 1 to 4, wherein the molecular sieve is selected from zeolites having a framework type of AEI, AEL, AFI, AFT, AFO, AFX, AFR, ATO, BEA, CHA, DDR, EAB, EMT, ERI, EUO, FAU, FER, GME, HEU, JSR, KFI, LEV, LTA, LTL, LTN, MAZ, MEL, MFI, MOR, MOZ, MSO, MTW, MWW, OFF, RTH, SAS, SAT, SAV, SBS, SBT, SFW, SSF, SZR, TON, TSC and WEN.
6. The NH₃-SCR catalyst according to Embodiment 4 or 5, wherein the zeolites are in respective H-form, NH₄⁺-form or metal ion-exchanged form such as copper- and/or iron-exchanged form.
7. The NH₃-SCR catalyst according to any of Embodiments 1 to 6, wherein the molecular sieve is a zeolite having a framework type selected from the group consisting of BEA (e.g., Beta), CHA (e.g., chabazite), FAU (e.g., zeolite Y), FER (e.g., ferrierite), MFI (e.g., ZSM-5) and MOR (e.g., mordenite), preferably MFI (e.g., ZSM-5), more preferably MFI (e.g., ZSM-5) in its NH₄⁺-form.
8. The NH₃-SCR catalyst according to any of Embodiments 1 to 7, wherein the composite of manganese oxide, cerium oxide and a molecular sieve is prepared via a co-precipitation process or a sol-gel process, more preferably via a sol-gel process.
9. A sol-gel process for preparing the NH₃-SCR catalyst according to any of Embodiments 1 to 8, which includes steps of
(i) providing a suspension comprising a molecular sieve, a precursor of manganese oxide and a precursor of cerium oxide,
(ii) heating the suspension to form a gel, and
(iii) subjecting the gel to drying, grinding and calcining.
10. The sol-gel process according to Embodiment 9, wherein the suspension in step (i) comprises an aqueous medium, preferably water.
11. The sol-gel process according to Embodiment 9 or 10, wherein the suspension in step (i) comprises a complexing agent such as citric acid.
12. The process according to any of Embodiments 9 to 11, wherein the heating in step (ii) is carried out at a temperature in the range of 70° C. to 100° C.
13. The process according to any of Embodiments 9 to 12, wherein the calcining in step (iii) at a temperature in the range of 300° C. to 500° C., for example 300° C. or 400° C.
14. An NH₃-SCR article, which comprises an NH₃-SCR catalyst according to any of Embodiments 1 to 8 or an NH₃-SCR catalyst obtained from the sol-gel process according to any of Embodiments 9 to 13.
15. The NH₃-SCR article according to Embodiment 14, which is in form of shaped bodies such as extrudates, or coated structures.
16. The NH₃-SCR article according to Embodiment 15, which is in form of granulate extrudates or monolith extrudates.
17. The NH₃-SCR article according to Embodiment 15, which is in form of coated structures comprising the NH₃-SCR catalyst in a coating on a substrate.
18. The NH₃-SCR article according to Embodiment 17, wherein the substrate is a monolithic flow-through structure or a monolithic wall-flow structure.
19. A method for treatment of exhaust gases containing nitrogen oxides by selective catalytic reduction, which includes contacting the exhaust gas with an NH₃-SCR catalyst according to any of Embodiments 1 to 8, an NH₃-SCR article obtained from the sol-gel process according to any of Embodiments 9 to 13, or an NH₃-SCR article according to any of Embodiments 14 to 18 in the presence of ammonia or ammonia precursor as a reducing agent.
20. An exhaust gas treatment system for combustion engines, which comprises a reducing agent source, an NH₃-SCR article according to any of Embodiments 14 to 18, and optionally one or more of diesel oxidation catalyst (DOC), three-way conversion catalyst (TWC), four-way conversion catalyst (FWC), non-catalyzed or catalyzed soot filter (CSF), ammonia oxidation catalyst (AMOx), NOx trap, NOx absorber catalyst, hydrocarbon trap catalyst, sensor and mixer.
21. The exhaust gas treatment system according to Embodiment 20, which comprises a diesel oxidation catalyst located downstream of the engine and upstream of the NH₃-SCR article.
22. The exhaust gas treatment system according to Embodiment 20 or 21, which comprises a diesel oxidation catalyst and a catalyzed soot filter located downstream of the engine and upstream of the NH₃-SCR article.

The invention will be further illustrated by following Examples, which set forth particularly advantageous embodiments. While the Examples are provided to illustrate the present invention, they are not intended to limit it.

### EXAMPLES

### I. Materials

| | |
|---|---|
| Cu-SSZ-13 | SAR = 27, 3.2 wt % CuO, from Zeolyst |
| H-CHA | SAR = 27, H-form, from Zeolyst |
| H—Y | SAR = 30, H-form, from Zeolyst |
| Ferrierite | SAR = 20, NH₄⁺-form, from Zeolyst |
| Mordenite | SAR = 20, NH₄⁺-form, from Zeolyst |
| Beta | SAR = 25, NH₄⁺-form, from Zeolyst |
| H-ZSM-5 | Calcined NH₄⁺-ZSM-5 |
| Fe-ZSM-5 | SAR = 30, 0.41 wt % Fe₂O₃, from Zeolyst |
| NH₄⁺-ZSM-5 | SAR = 30, NH₄⁺-form, from Zeolyst |

### II. General Procedure of Preparations

### II.1 Preparation of a Composite Oxide of Mn and Ce (MnCeOx) by a Sol-Gel Method

A mixture of Mn(NO₃)₄·4H₂O, Ce(NO₃)₃·6H₂O and citric acid in a molar ratio of 1:1:2 was dissolved in deionized water at a mixture to water ratio of 1:50 by weight under stirring, and subjected to heating under 90° C. until gel formed. The gel was dried at 80° C. in an oven overnight. The obtained solid was ground into a powder with particle size of 40-60 meshes, and calcined in a muffle under 300° C. for 4 hours.

### II.2 Preparation of a Mn/Ce/Zeolite Composite by a Co-Precipitation Method

A mixture of Mn(NO₃)₄·4H₂O, Ce(NO₃)₃·6H₂O and zeolite in certain amounts as specified for each composite sample was prepared. The mixture was dissolved with deionized (DI) water at a mixture to water ratio of 1:50 by weight. Then ammonia was added into the resulted suspension to adjust pH to 11, and stirred at a room temperature until sediment formed. The sediment was separated by filtering and washing, and then dried in an oven overnight. Finally, the obtained solid was ground into a powder with particle size of 40-60 meshes, and calcined in a muffle under 300° C. for 4 hours. A composite of manganese oxide, cerium oxide and zeolite was provided, designated as Mn/Ce/Zeolite, such as Mn/Ce/NH₄⁺-ZSM-5.

### II.3 Preparation of a Mn/Ce/Zeolite Composite by a Sol-Gel Method

A mixture of Mn(NO₃)₄·4H₂O, Ce(NO₃)₃·6H₂O and citric acid in a molar ratio of (Mn+Ce) to citric acid of 1:2 was prepared and a certain amount of zeolite was added into the mixture. The mixture was dissolved with deionized (DI) water at a mixture to water ratio of 1:50 by weight under stirring, and subjected to heating under 90° C. until gel formed. The gel was dried at 80° C. in an oven overnight. The obtained solid was ground into a powder with particle size of 40-60 meshes, and calcined in a muffle under 300° C. or 400° C. for 4 hours. A composite of manganese oxide, cerium oxide and zeolite was provided, designated as Mn/Ce/Zeolite, such as Mn/Ce/NH₄⁺-ZSM-5.

II.4 Preparation of a Compounded Mixture of MnCeOₓ and Zeolite by Grinding a Mixture of MnCeOₓ and Zeolite (Grinding Method)

A mixture of Mn(NO₃)₄·4H₂O, Ce(NO₃)₃·6H₂O and citric acid in molar ratio of (Mn+Ce) to citric acid of 1:2 was prepared, and then dissolved with deionized water at a mixture to water ratio of 1:0.3 by weight under stirring, and subjected to heating under 90° C. until gel formed. The gel was dried in an oven at 80° C. overnight. The obtained solid was ground into a powder, and calcined in a muffle under 300° C. for 4 hours to obtain a Mn/Ce composite oxide (i.e., MnCeOₓ). A certain amount of MnCeOₓ was mixed with a zeolite and ground into powder with particle size of 40-60 meshes. A compounded mixture of MnCeOx and a zeolite was provided, designated as MnCeOₓ/Zeolite, such as MnCeOₓ/NH₄⁺-ZSM-5.

### II.5 Preparation of a Compounded Mixture of MnCeOₓ and Zeolite by a Water Mixture Method

A mixture of Mn(NO₃)₄·4H₂O, Ce(NO₃)₃·6H₂O and citric acid in molar ratio of 1:1:2 was prepared, and then dissolved with deionized water at a mixture to water ratio of 1:50 by weight under stirring, and subjected to heating under 90° C. until gel formed. The gel was dried in an oven at 80° C. overnight. The obtained solid was ground into a powder, and calcined in a muffle under 300° C. for 4 hours to obtain a Mn/Ce composite oxide (i.e., MnCeOₓ). Then certain amounts of MnCeOₓ and a zeolite were mixed with proper amount of deionized water to highly disperse the MnCeOₓ and the zeolite. The resulted sediment was filtered, washed, and dried in an oven at 80° C. overnight. The solid as obtained was ground into a powder with particle size of 40-60 meshes, and calcined in a muffle for under 300° C. 4 hours. A compounded mixture of MnCeOₓ and a zeolite was provided, designated as MnCeOₓ/Zeolite, such as MnCeOₓ/NH₄⁺-ZSM-5.

### II.6 Preparation of a Mn/Ce/Zeolite Composite by Impregnation Method

A mixture of Mn(NO₃)₄·4H₂O and Ce(NO₃)₃·6H₂O in molar ratio of 1:1 was dissolved with deionized water at a mixture to water ratio of 1:0.3 by weight. To the resulted solution, a certain amount of zeolite was added and stirring was kept for 2 hours. Then the resulted sediment was filtered, washed, and dried at 80° C. in an oven overnight. The solid as obtained was ground into powder with particle size of 40-60 meshes, and calcined in a muffle under 300° C. for 4 hours. A composite of manganese oxide, cerium oxide and zeolite was provided, designated as Mn/Ce/Zeolite, such as Mn/Ce/NH₄⁺-ZSM-5.

### III. Characterization Methods

The X-ray diffraction (XRD) experiments were carried out on a Rigaku D/MAS-RB X-ray diffractometer with Cu Kα (40 kV, 40 mA) radiation, and the XRD patterns were recorded in the 20 range of 10° to 90° with a scan rate of 8°/min.

The SEM-EDS characterization was carried out on a field-emission 69 scanning electron microscopy (FE-SEM, SIGMA-3000). Energy Dispersive Spectroscopy (EDS) 70 mapping of catalysts were completed on Oxford Instruments EDS.

Nitrogen adsorption-desorption tests were measured at 77 K using a U.S. Quantachrome ASAP 2020M nitrogen adsorption instrument, and the specific surface area was calculated by the Brunaue-Emmett-Teller (BET) method. The samples were degassed at 200° C. for 10 h before the experiment.

### IV. SCR Performance Measurement

SCR performance were performed using a fixed-bed quartz flow reactor (Inner diameter=4 mm) and 0.15 g of the catalyst with 40-60 meshes. SCR activity measurements were carried out in the temperature range of 90-480° C.

The gas stream as used consists of 500 vppm NO, 500 vppm NH₃, 10 vol % O₂, 5 vol % H₂O, 5 vol % CO₂, and N₂ as balance gas. The total flow rate was controlled to 475 mL·min⁻¹, corresponding to a gas hourly space velocity (GHSV, weight) of 200,000 mL·g⁻¹·h⁻¹, GHSV (volume) of 150,000 h⁻¹ with the assistant of cordierite to make the volume of all catalysts to be the same.

For measurements of aged samples, the fresh samples as prepared were hydrothermally treated in an atmosphere of air with 10% H₂O at 650° C. for 50 hours before the measurements.

The gas concentrations of NO, NO₂, NH₃, H₂O, and N₂O were simultaneously monitored by an FTIR spectrometer (Themo Fisher). The SCR catalytic activity was recorded after the reaction system reached a steady state. The NOx conversion was calculated with reference to the following equation:

$${NO}_{x} conversion ( \% ) = \frac{{[ {NO}_{x} ]}_{in} - {[ {NO}_{x} ]}_{out}}{{[ {NO}_{x} ]}_{in}} \times 100 \%$$

The test results were summarized in following Tables.

TABLE 1

| | NOx conversion, % | | | | | | N₂O, ppm | | | | | |
|---|---|---|---|---|---|---|---|---|---|---|---|---|
| | 100° C. | 150° C. | 200° C. | 250° C. | 300° C. | 350° C. | 100° C. | 150° C. | 200° C. | 250° C. | 300° C. | 350° C. |
| | fresh | | | | | | | | | | | |
| MnCeOₓ | 85 | 99 | 99 | 97 | 91 | 64 | 45 | 160 | 324 | 345 | 291 | 195 |
| Cu-SSZ-13 | 8 | 22 | 63 | 98 | 100 | 100 | 0 | 1 | 2 | 1 | 5 | 6 |
| Mn/Ce/H-Y | 61 | 98 | 100 | 100 | 97 | 89 | 6 | 22 | 78 | 101 | 108 | 115 |
| Mn/Ce/NH₄⁺- | 39 | 83 | 100 | 100 | 98 | 89 | 4 | 16 | 67 | 24 | 77 | 106 |
| ZSM-5 | | | | | | | | | | | | |
| Mn/Ce/Ferrierite | 53 | 90 | 100 | 100 | 95 | 91 | 14 | 71 | 235 | 121 | 78 | 93 |
| Mn/Ce/Mordenite | 55 | 90 | 100 | 100 | 94 | 83 | 8 | 66 | 49 | 169 | 150 | 134 |
| Mn/Co/NH₄⁺- | 87 | 96 | 100 | 99 | 96 | 83 | 28 | 87 | 183 | 185 | 144 | 106 |
| ZSM-5 | | | | | | | | | | | | |
| Mn/Sm/NH₄⁺- | 11 | 54 | 97 | 99 | 98 | 92 | 1 | 4 | 40 | 76 | 69 | 69 |
| ZSM-5 | | | | | | | | | | | | |
| | aged | | | | | | | | | | | |
| MnCeOₓ | 84 | 99 | 99 | 98 | 90 | 71 | 40 | 137 | 284 | 353 | 308 | 234 |
| Cu-SSZ-13 | 10 | 54 | 98 | 99 | 100 | 100 | 1 | 2 | 6 | 6 | 5 | 4 |
| Mn/Ce/H-Y | 11 | 43 | 89 | 99 | 99 | 93 | 1 | 11 | 50 | 74 | 28 | 94 |
| Mn/Ce/NH₄⁺- | 25 | 79 | 96 | 100 | 100 | 99 | 4 | 24 | 25 | 48 | 52 | 65 |
| ZSM-5 | | | | | | | | | | | | |
| Mn/Ce/Ferrierite | 49 | 94 | 99 | 99 | 94 | 84 | 19 | 74 | 69 | 223 | 173 | 134 |
| Mn/Ce/Mordenite | 21 | 23 | 150 | 96 | 97 | 93 | 6 | 62 | 150 | 214 | 143 | 77 |
| Mn/Co/NH₄⁺- | 25 | 37 | 77 | 95 | 98 | 93 | 10 | 78 | 204 | 254 | 137 | 110 |
| ZSM-5 | | | | | | | | | | | | |
| Mn/Sm/NH₄⁺- | 12 | 41 | 87 | 99 | 97 | 93 | 1 | 3 | 26 | 54 | 82 | 55 |
| ZSM-5 | | | | | | | | | | | | |

The composites of manganese oxide, cerium oxide and zeolite shown in Table 1 all have a mass ratio of the sum of manganese oxide and cerium oxide to zeolite of 1.5:1, a molar ratio of Mn:Ce of 1:1, which were prepared by a gel-sol process following the general procedure as described under II.3 hereinabove and the calcination temperature is 300° C. The composites of Mn/Co/NH₄⁺-ZSM-5 and Mn/Sm/NH₄⁺-ZSM-5 are prepared following the same procedure and have a mass ratio of the sum of manganese oxide and cobalt oxide (or the sum of manganese oxide and samarium oxide) to zeolite of 1.5:1, a molar ratio of Mn:Co (or Sm) of 1:1.

It can be seen from the test results shown in Table 1, the composites of manganese oxide, cerium oxide and zeolite according to the present invention exhibit much higher low-temperature NOx conversions than conventional Cu-SSZ-13. The low-temperature NOx conversions of the composites of manganese oxide, cerium oxide and zeolite according to the present invention are comparable or slightly lower than the conventional MnCeOₓ, while the N₂O generation is much lower than the conventional MnCeOₓ.

It can also be seen that fresh composite Mn/Ce/NH₄⁺-ZSM-5 according to the present invention exhibits much higher low-temperature NOx conversion than the fresh composite Mn/Sm/NH₄⁺-ZSM-5 and much lower N₂O generation than the fresh composite of Mn/Co/NH₄⁺-ZSM-5. Moreover, the aged composite Mn/Ce/NH₄⁺-ZSM-5 according to the present invention exhibits both much higher low-temperature NOx conversion and less N₂O generation than the aged composites Mn/Co/NH₄⁺-ZSM-5 and Mn/Sm/NH₄⁺-ZSM-5. Therefore, the composite of Mn/Ce/NH₄⁺-ZSM-5 is better than Mn/Co/NH₄⁺-ZSM-5 and Mn/Sm/NH₄⁺-ZSM-5 as a catalyst for SCR applications.

TABLE 2

| | NOx conversion, % | | | | | | N₂O, ppm | | | | | |
|---|---|---|---|---|---|---|---|---|---|---|---|---|
| | 100° C. | 150° C. | 200° C. | 250° C. | 300° C. | 350° C. | 100° C. | 150° C. | 200° C. | 250° C. | 300° C. | 350° C. |
| | fresh | | | | | | | | | | | |
| MnCeOₓ | 70 | 91 | 98 | 94 | 86 | 60 | 26 | 91 | 229 | 317 | 265 | 201 |
| Mn/Ce/H-Y | 44 | 94 | 100 | 100 | 97 | 90 | 10 | 80 | 141 | 138 | 130 | 125 |
| Mn/Ce/NH₄⁺- | 41 | 94 | 100 | 99 | 97 | 94 | 2 | 9 | 80 | 141 | 43 | 91 |
| ZSM-5 | | | | | | | | | | | | |
| Mn/Ce/Beta | 34 | 79 | 99 | 100 | 99 | 92 | 1 | 17 | 59 | 25 | 24 | 74 |
| Mn/Ce/H- | 56 | 91 | 99 | 99 | 95 | 85 | 6 | 76 | 234 | 156 | 157 | 121 |
| CHA | | | | | | | | | | | | |
| | aged | | | | | | | | | | | |
| MnCeOₓ | 82 | 98 | 100 | 96 | 89 | 65 | 27 | 117 | 346 | 50 | 334 | 223 |
| Mn/Ce/H-Y | 12 | 56 | 93 | 100 | 96 | 74 | 2 | 18 | 54 | 48 | 51 | 1 |
| Mn/Ce/NH₄⁺- | 60 | 89 | 98 | 100 | 98 | 88 | 14 | 29 | 34 | 99 | 127 | 106 |
| ZSM-5 | | | | | | | | | | | | |
| Mn/Ce/Beta | 9 | 24 | 70 | 95 | 99 | 96 | 1 | 2 | 13 | 23 | 70 | 62 |
| Mn/Ce/H- | 71 | 98 | 100 | 100 | 97 | 89 | 17 | 77 | 160 | 208 | 170 | 140 |
| CHA | | | | | | | | | | | | |

The composites of manganese oxide, cerium oxide and zeolite shown in Table 2 all have a mass ratio of the sum of manganese oxide and cerium oxide to zeolite of 1.5:1, a molar ratio of Mn:Ce of 1:1, which were prepared by a gel-sol process following the general procedure as described under II.3 hereinabove and the calcination temperature is 400° C.

It can be seen from the test results shown in Table 2, the composites of manganese oxide, cerium oxide and zeolite according to the present invention prepared under a higher calcination temperature still exhibit low-temperature NOx conversions comparable or slightly lower than the conventional MnCeOₓ, while the N₂O generation is much lower than the conventional MnCeOₓ.

TABLE 3

| | NOx conversion, % | | | | | | N₂O, ppm | | | | | |
|---|---|---|---|---|---|---|---|---|---|---|---|---|
| | 100° C. | 150° C. | 200° C. | 250° C. | 300° C. | 350° C. | 100° C. | 150° C. | 200° C. | 250° C. | 300° C. | 350° C. |
| | fresh | | | | | | | | | | | |
| Mn/Ce/H-ZSM-5 | 61 | 96 | 100 | 99 | 96 | 91 | 6 | 40 | 114 | 110 | 143 | 128 |
| (1:1.5) | | | | | | | | | | | | |
| Mn/Ce/NH₄⁺-ZSM-5 | 39 | 83 | 100 | 100 | 98 | 89 | 4 | 16 | 67 | 24 | 77 | 106 |
| (1:1.5) | | | | | | | | | | | | |
| Mn/Ce/NH₄⁺-ZSM-5 | 39 | 83 | 100 | 100 | 98 | 89 | 4 | 16 | 67 | 24 | 77 | 106 |
| (1.5:1) | | | | | | | | | | | | |
| Mn/Ce/Fe-ZSM-5 | 48 | 92 | 100 | 98 | 96 | 92 | 3 | 24 | 76 | 121 | 91 | 76 |
| (1.5:1) | | | | | | | | | | | | |
| | aged | | | | | | | | | | | |
| Mn/Ce/H-ZSM-5 | 68 | 89 | 99 | 100 | 98 | 91 | 20 | 29 | 42 | 130 | 97 | 86 |
| (1:1.5) | | | | | | | | | | | | |
| Mn/Ce/NH₄⁺-ZSM-5 | 55 | 87 | 97 | 100 | 97 | 89 | 16 | 43 | 19 | 44 | 104 | 113 |
| (1:1.5) | | | | | | | | | | | | |
| Mn/Ce/NH₄⁺-ZSM-5 | 25 | 79 | 96 | 100 | 100 | 99 | 4 | 24 | 25 | 48 | 52 | 65 |
| (1.5:1) | | | | | | | | | | | | |
| Mn/Ce/Fe-ZSM-5 | 34 | 80 | 96 | 99 | 97 | 89 | 7 | 58 | 124 | 167 | 123 | 121 |
| (1.5:1) | | | | | | | | | | | | |

The composites of manganese oxide, cerium oxide and zeolite shown in Table 3 all have a mass ratio of the sum of manganese oxide and cerium oxide to zeolite as indicated within brackets and have a molar ratio of Mn:Ce of 1:1, which were prepared by a gel-sol process following the general procedure as described under II.3 hereinabove and the calcination temperature is 300° C.

It can be seen from the results shown in Table 3, the composites of manganese oxide, cerium oxide and various forms of ZSM-5 according to the present invention can exhibit good low-temperature NOx conversions and lower N₂O generation than MnCeOₓ, among which the composite Mn/Ce/NH₄⁺-ZSM-5 is better for SCR applications.

TABLE 4

| | NOx conversion, % | | | | | | N₂O, ppm | | | | | |
|---|---|---|---|---|---|---|---|---|---|---|---|---|
| | 100° C. | 150° C. | 200° C. | 250° C. | 300° C. | 350° C. | 100° C. | 150° C. | 200° C. | 250° C. | 300° C. | 350° C. |
| Mn/Ce/NH₄⁺-ZSM-5 | fresh | | | | | | | | | | | |
| MnCe:NH₄⁺-ZSM-5 = | 37 | 85 | 100 | 99 | 98 | 95 | 3 | 23 | 43 | 86 | 31 | 77 |
| 1:1 | | | | | | | | | | | | |
| MnCe:NH₄⁺-ZSM-5 = | 39 | 87 | 99 | 99 | 98 | 93 | 4 | 13 | 13 | 74 | 53 | 53 |
| 1.5:1 | | | | | | | | | | | | |
| MnCe:NH₄⁺-ZSM-5 = | 42 | 88 | 97 | 98 | 95 | 83 | 7 | 31 | 68 | 55 | 118 | 134 |
| 3:1 | | | | | | | | | | | | |

The composites of Mn/Ce/NH₄⁺-ZSM-5 shown in Table 4 all have a mass ratio of the sum of manganese oxide and cerium oxide to zeolite as indicated and have a molar ratio of Mn:Ce of 1:1, which were prepared by a gel-sol process following the general procedure as described under II.3 hereinabove and the calcination temperature is 300° C.

It can be seen from the results shown in Table 4, the composites of manganese oxide, cerium oxide and NH₄⁺-ZSM-5 at different mass ratios of MnCeOₓ:zeolite all can exhibit good low-temperature NOx conversions and lower N₂O generation than MnCeOₓ, among which the composite Mn/Ce/NH₄⁺-ZSM-5 having a mass ratio of the sum of manganese oxide and cerium oxide to zeolite of 1.5:1 is the best.

TABLE 5

| Mn/Ce/NH₄⁺- | NOx conversion, % | | | | | | N₂O, ppm | | | | | |
|---|---|---|---|---|---|---|---|---|---|---|---|---|
| ZSM-5 | 100° C. | 150° C. | 200° C. | 250° C. | 300° C. | 350° C. | 100° C. | 150° C. | 200° C. | 250° C. | 300° C. | 350° C. |
| | fresh | | | | | | | | | | | |
| Mn/Ce 4:1 | 84 | 98 | 100 | 99 | 98 | 87 | 26 | 91 | 147 | 145 | 138 | 124 |
| Mn/Ce 7:3 | 61 | 92 | 100 | 100 | 97 | 85 | 8 | 39 | 102 | 141 | 123 | 115 |
| Mn/Ce 1:1 | 39 | 83 | 100 | 100 | 98 | 89 | 4 | 16 | 67 | 24 | 77 | 106 |
| Mn/Ce 3:7 | 33 | 87 | 99 | 100 | 98 | 93 | 3 | 28 | 81 | 98 | 83 | 82 |
| Mn/Ce 1:4 | 28 | 78 | 98 | 100 | 98 | 91 | 1 | 8 | 23 | 66 | 77 | 65 |
| | aged | | | | | | | | | | | |
| Mn/Ce 4:1 | 51 | 90 | 99 | 99 | 97 | 90 | 17 | 69 | 104 | 95 | 103 | 92 |
| Mn/Ce 7:3 | 64 | 91 | 98 | 100 | 98 | 88 | 26 | 59 | 98 | 126 | 121 | 107 |
| Mn/Ce 1:1 | 25 | 79 | 96 | 100 | 100 | 99 | 4 | 24 | 25 | 48 | 52 | 65 |
| Mn/Ce 3:7 | 28 | 74 | 94 | 100 | 98 | 90 | 6 | 43 | 98 | 141 | 131 | 103 |
| Mn/Ce 1:4 | 73 | 93 | 100 | 100 | 99 | 93 | 33 | 79 | 110 | 119 | 106 | 79 |

The composites of MnCe+NH₄⁺-ZSM-5 shown in Table 5 all have a mass ratio of the sum of manganese oxide and cerium oxide to zeolite of 1.5:1 and have a molar ratio of Mn:Ce as indicated, which were prepared by a gel-sol process following the general procedure as described under II.3 hereinabove and the calcination temperature is 300° C.

It can be seen from the results shown in Table 5, the composites of MnCe/NH₄⁺-ZSM-5 with different molar ratios of Mn:Ce all can exhibit good low-temperature NOx conversions and lower N₂O generation than MnCeOₓ, among which the composite Mn/Ce/NH₄⁺-ZSM-5 having a molar ratio of Mn:Ce of 1:1 is the best.

TABLE 6

| | NOx conversion, % | | | | | | N₂O, ppm | | | | | |
|---|---|---|---|---|---|---|---|---|---|---|---|---|
| | 100° C. | 150° C. | 200° C. | 250° C. | 300° C. | 350° C. | 100° C. | 150° C. | 200° C. | 250° C. | 300° C. | 350° C. |
| | fresh | | | | | | | | | | | |
| Mn/Ce/NH₄⁺-ZSM-5 | 39 | 83 | 100 | 100 | 98 | 89 | 4 | 16 | 67 | 24 | 77 | 106 |
| (sol-gel) | | | | | | | | | | | | |
| Mn/Ce/NH₄⁺-ZSM-5 | 67 | 94 | 98 | 100 | 97 | 92 | 10 | 47 | 113 | 121 | 88 | 66 |
| (co-precipitation) | | | | | | | | | | | | |
| MnCeOₓ/NH₄⁺-ZSM-5 | 47 | 92 | 100 | 100 | 97 | 87 | 10 | 38 | 119 | 130 | 87 | 81 |
| (grinding method) | | | | | | | | | | | | |
| MnCeOₓ/NH₄⁺-ZSM-5 | 40 | 96 | 100 | 100 | 97 | 91 | 4 | 50 | 76 | 124 | 96 | 65 |
| (water mixture method) | | | | | | | | | | | | |
| Mn/Ce/NH₄⁺-ZSM-5 | 10 | 47 | 96 | 100 | 100 | 96 | 2 | 10 | 52 | 73 | 54 | 45 |
| (impregnation) | | | | | | | | | | | | |
| | aged | | | | | | | | | | | |
| Mn/Ce/NH₄⁺-ZSM-5 | 25 | 79 | 96 | 100 | 100 | 99 | 4 | 24 | 25 | 48 | 52 | 65 |
| (sol-gel) | | | | | | | | | | | | |
| Mn/Ce/NH₄⁺-ZSM-5 | 45 | 83 | 97 | 100 | 98 | 92 | 8 | 37 | 95 | 158 | 125 | 68 |
| (co-precipitation) | | | | | | | | | | | | |
| MnCeOₓ/NH₄⁺-ZSM-5 | 26 | 65 | 93 | 99 | 97 | 94 | 4 | 39 | 98 | 128 | 132 | 87 |
| (grinding method) | | | | | | | | | | | | |
| MnCeOₓ/NH₄⁺-ZSM-5 | 33 | 58 | 95 | 99 | 98 | 90 | 4 | 19 | 69 | 134 | 101 | 100 |
| (water mixture method) | | | | | | | | | | | | |
| Mn/Ce/NH₄⁺-ZSM-5 | 12 | 29 | 72 | 98 | 100 | 95 | 1 | 7 | 30 | 81 | 81 | 75 |
| (impregnation) | | | | | | | | | | | | |

The composites or compounded mixture shown in Table 6 all have a mass ratio of the sum of manganese oxide and cerium oxide to zeolite of 1.5:1 and have a molar ratio of Mn:Ce of 1:1, which were prepared by respective processes as indicated and the calcination temperature is 300° C.

It can be seen from the results shown in Table 6, the composite of Mn/Ce/NH₄⁺-ZSM-5 as prepared from the sol-gel method exhibits the lowest N₂O generation among all samples. The gel-sol method is the best way to prepare the composite of manganese oxide, cerium oxide and zeolite according to the present invention.

### V. Characterization Results

### N₂ Adsorption and Desorption

The composite Mn/Ce/NH₄⁺-ZSM-5 for the N₂ adsorption and desorption characterization has a mass ratio of the sum of manganese oxide and cerium oxide to NH₄⁺-ZSM-5 of 1.5:1 and a molar ratio of Mn:Ce of 1:1, which was prepared by a gel-sol method with the calcination temperature of 300° C. The MnCeOₓ was prepared by a gel-sol method with a molar ratio of Mn:Ce of 1:1.

The results are summarized in Table 7.

TABLE 7

| | Specific | Pore | Pore |
|---|---|---|---|
| | surface area | diameter | volume |
| Catalysts | (m² g⁻¹) | (nm) | (cm³ g⁻¹) |
| MnCeOₓ (Fresh) | 80 | 5.16 | 0.31 |
| Mn/Ce/NH₄⁺-ZSM-5 (Fresh) | 174 | 6.27 | 0.25 |
| NH₄⁺-ZSM-5 (Fresh) | 341 | 7.23 | 0.26 |
| MnCeOₓ (Aged) | 35 | 16.25 | 0.21 |
| Mn/Ce/NH₄⁺-ZSM-5 (Aged) | 147 | 9.37 | 0.21 |
| NH₄⁺-ZSM-5 (Aged) | 354 | 4.92 | 0.27 |

From the analysis of N₂ adsorption and desorption, the specific surface area (80 m² g⁻¹) of MnCeOₓ decreases largely to 35 m² g⁻¹ after aging. As a comparison, the specific surface area (174 m² g⁻¹) of Mn/Ce/NH₄⁺-ZSM-5 only decreases to 147 m² g⁻¹ after aging. It is noted that the composite Mn/Ce/NH₄⁺-ZSM-5 could maintain a high specific surface area after aging.

### XRD Analysis and SEM-EDS Analysis

The composite Mn/Ce/NH₄⁺-ZSM-5 for the XRD analysis and SEM-EDS has a mass ratio of the sum of manganese oxide and cerium oxide to NH₄⁺-ZSM-5 of 1.5:1 and a molar ratio of Mn:Ce of 1:1, which was prepared by a gel-sol method with the calcination temperature of 300° C. The MnCeOₓ was prepared by a gel-sol method with a molar ratio of Mn:Ce of 1:1.

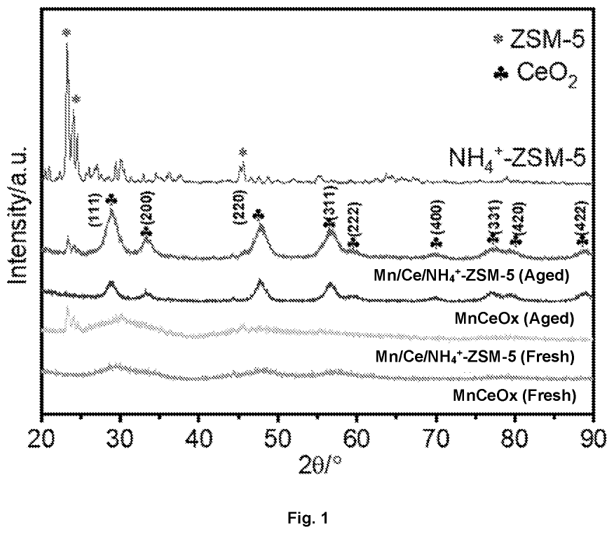

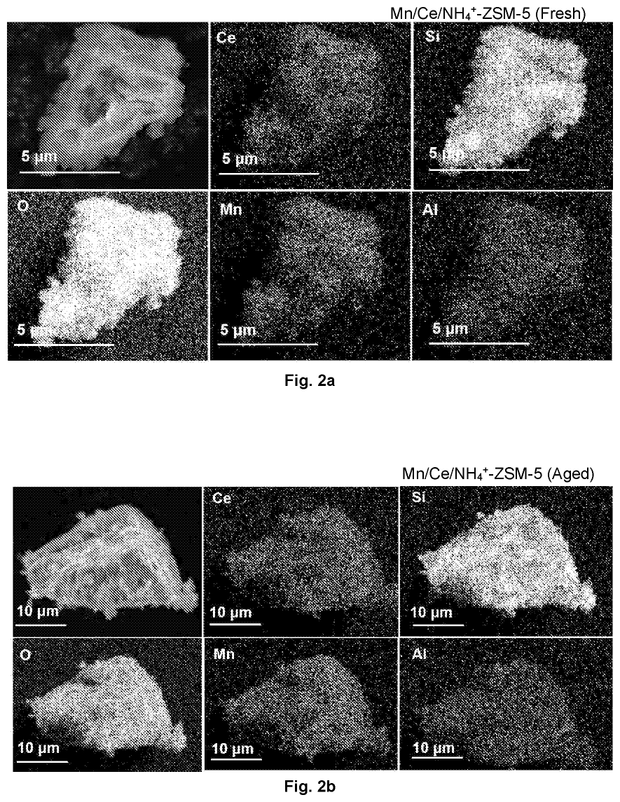

The XRD results are shown in Table 8 and FIG. 1; and the SEM-EDS images are shown in FIG. 2a and FIG. 2b.

TABLE 8
The crystalline grain of CeO₂[111] of fresh and aged samples

| | CeO₂[111] |
|---|---|
| Samples | Crystal grain size (nm) |
| MnCeOₓ (fresh) | 3.6 |
| Mn/Ce/NH₄⁺-ZSM-5 (fresh) | 3.1 |
| MnCeOₓ (Aged) | 7.6 |
| Mn/Ce/NH₄⁺-ZSM-5 (Aged) | 5.7 |

Although the invention herein has been described with reference to particular embodiments, it is to be understood that these embodiments are merely illustrative of the principles and applications of the present invention. It will be apparent to those of skill in the art that various modifications and variations can be made to the method and apparatus of the present invention without departing from the spirit and scope of the invention. Thus, it is intended that the present invention include modifications and variations that are within the scope of the appended claims and their equivalents.

1-22. (canceled)

23. An NH3-SCR catalyst, which comprises, particularly consists of, a composite of manganese oxide, cerium oxide and a molecular sieve, wherein the molecular sieve is present in an amount of 20% to 70% by weight, based on the total weight of the composite.

24. The NH3-SCR catalyst according to claim 23, wherein the molecular sieve is present in the composite of manganese oxide, cerium oxide and a molecular sieve in an amount of 20% to 50% by weight, more preferably 35% to 45% by weight, based on the total weight of the composite.

25. The NH3-SCR catalyst according to claim 23, wherein manganese oxide and cerium oxide are present at a molar ratio in the range of 4:1 to 1:4, preferably in the range of 7:3 to 3:7, more preferably in the range of 3:2 to 2:3, calculated as Mn and Ce elements.

26. The NH3-SCR catalyst according to claim 23, wherein the molecular sieve is selected from zeolites having a framework type of ABW, ACO, AEI, AEL, AEN, AET, AFG, AFI, AFN, AFO, AFR, AFS, AFT, AFV, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, -CHI, -CLO, CON, CSV, CZP, DAC, DDR, DFO, DFT, DOH, DON, EAB, EDI, EEI, EMT, EON, EPI, ERI, ESV, ETR, EUO, *-EWT, EZT, FAR, FAU, FER, FRA, GIS, GIU, GME, GON, GOO, HEU, IFO, IFR, -IFU, IFW, IFY, IHW, IMF, IRN, IRR, -IRY, ISV, ITE, ITG, ITH, *-ITN, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, *MRE, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POS, PSI, PUN, RHO, -RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, *SFV, SFW, SGT, SIV, SOD, SOF, SOS, SSF, *-SSO, SSY, STF, STI, *STO, STT, STW, -SVR, SVV, SZR, TER, THO, TOL, TON, TSC, TUN, UEI, UFI, UOS, UOV, UOZ, USI, UTL, UWY, VET, VFI, VNI, VSV, WEI, -WEN, YUG and ZON, preferably wherein the molecular sieve is selected from zeolites having a framework type of AEI, AEL, AFI, AFT, AFO, AFX, AFR, ATO, BEA, CHA, DDR, EAB, EMT, ERI, EUO, FAU, FER, GME, HEU, JSR, KFI, LEV, LTA, LTL, LTN, MAZ, MEL, MFI, MOR, MOZ, MSO, MTW, MWW, OFF, RTH, SAS, SAT, SAV, SBS, SBT, SFW, SSF, SZR, TON, TSC and WEN.

27. The NH3-SCR catalyst according to claim 26, wherein the zeolites are in respective H-form, NH4+-form or metal ion-exchanged form such as copper- and/or iron-exchanged form.

28. The NH3-SCR catalyst according to claim 23, wherein the molecular sieve is a zeolite having a framework type selected from the group consisting of BEA (e.g., Beta), CHA (e.g., chabazite), FAU (e.g., zeolite Y), FER (e.g., ferrierite), MFI (e.g., ZSM-5) and MOR (e.g., mordenite), preferably MFI (e.g., ZSM-5), more preferably MFI (e.g., ZSM-5) in its NH4+-form.

29. The NH3-SCR catalyst according to claim 23, wherein the composite of manganese oxide, cerium oxide and a molecular sieve is prepared via a co-precipitation process or a sol-gel process, more preferably via a sol-gel process.

30. A sol-gel process for preparing the NH3-SCR catalyst according to claim 23, which includes steps of
(i) providing a suspension comprising a molecular sieve, a precursor of manganese oxide and a precursor of cerium oxide,
(ii) heating the suspension to form a gel, and
(iii) subjecting the gel to drying, grinding and calcining.

31. The sol-gel process according to claim 30, wherein the suspension in step (i) comprises an aqueous medium, preferably water.

32. The sol-gel process according to claim 30, wherein the suspension in step (i) comprises a complexing agent such as citric acid.

33. The sol-gel process according to claim 30, wherein the heating in step (ii) is carried out at a temperature in the range of 70° C. to 100° C.

34. The sol-gel process according to claim 30, wherein the calcining in step (iii) at a temperature in the range of 300° C. to 500° C., for example 300° C. or 400° C.

35. An NH3-SCR article, which comprises the NH3-SCR catalyst according to claim 23 or the NH3-SCR catalyst obtained from a sol-gel process, the process includes steps of
(i) providing a suspension comprising a molecular sieve, a precursor of manganese oxide and a precursor of cerium oxide,
(ii) heating the suspension to form a gel, and
(iii) subjecting the gel to drying, grinding and calcining.

36. The NH3-SCR article according to claim 35, which is in form of shaped bodies such as extrudates, preferably granulate extrudates or monolith extrudates, or coated structures.

37. The NH3-SCR article according to claim 36, which is in form of coated structures comprising the NH3-SCR catalyst in a coating on a substrate.

38. The NH3-SCR article according to claim 37, wherein the substrate is a monolithic flow-through structure or a monolithic wall-flow structure.

39. A method for treatment of exhaust gases containing nitrogen oxides by selective catalytic reduction, which includes contacting the exhaust gas with an NH3-SCR catalyst according to claim 23, an NH3-SCR article obtained from the sol-gel process the process includes steps of: (i) providing a suspension comprising a molecular sieve, a precursor of manganese oxide and a precursor of cerium oxide, (ii) heating the suspension to form a gel, and (iii) subjecting the gel to drying, grinding and calcining; or the NH3-SCR article which is in form of shaped bodies such as extrudates, preferably granulate extrudates or monolith extrudates, or coated structures, in the presence of ammonia or ammonia precursor as a reducing agent.

40. An exhaust gas treatment system for combustion engines, which comprises a reducing agent source, an NH3-SCR article according to claim 35, and optionally one or more of diesel oxidation catalyst (DOC), three-way conversion catalyst (TWC), four-way conversion catalyst (FWC), non-catalyzed or catalyzed soot filter (CSF), ammonia oxidation catalyst (AMOx), NOx trap, NOx absorber catalyst, hydrocarbon trap catalyst, sensor and mixer.

41. The exhaust gas treatment system according to claim 40, which comprises a diesel oxidation catalyst located downstream of the engine and upstream of the NH3-SCR article.

42. The exhaust gas treatment system according to claim 40, which comprises a diesel oxidation catalyst and a catalyzed soot filter located downstream of the engine and upstream of the NH3-SCR article.
